(19) United States
(12) Patent Application Publication
(10) Pub. No.: US 2021/0170439 A1
(43) Pub. Date: Jun. 10, 2021

(54) ABSORBENT MATERIAL ON A NONWOVEN FABRIC BASIS

(71) Applicant: Tenowo GmbH, Hof (DE)

(72) Inventors: Anja Schumann, Mittweida (DE); Ervin Yildiz-Franke, Zwickau (DE)

(21) Appl. No.: 16/944,464

(22) Filed: Jul. 31, 2020

(30) Foreign Application Priority Data
Jul. 31, 2019 (DE) 10 2019 126 148.1

(51) Int. Cl. B05C 17/02; D04H 11/08

(52) U.S. Cl. CPC B05C 17/0207; D04H 1/435; D04H 11/08

(57) ABSTRACT

The invention relates to an absorbent material on a nonwoven fabric basis, consisting of a fibrous gauze preferably having a longitudinally oriented initial fiber position, which is solidified by mesh formation while obtaining a three-dimensional fiber order. Furthermore, a fiber pile layer having a mainly vertical fiber orientation is formed, wherein the fiber pile layer has largely preponderantly a loop shape in a manner avoiding fiber tear-out. The material is in particular suitable for being used as a paint roller covering or dye-feeding roller, i.e. for applying liquid substances onto surface structures.

The invention relates to an absorbent material on a nonwoven fabric basis, a method for producing such a material, as well as a paint roller covering or dye-feeding roller covering, comprising a pile fiber nonwoven fabric.

The absorbent material on the nonwoven fabric basis takes a fibrous gauze as a basis preferably having a longitudinally oriented initial fiber position, which is solidified by mesh formation while obtaining a three-dimensional fiber order, according to the preamble of claim 1. As far as the method is concerned, an initial fiber mixture is laid so as to form a fibrous gauze, and subsequently, a densification is performed by means of mesh formation due to unilateral fiber pile formation, wherein the obtained fiber pile layer preponderantly is realized in the form of loops, according to claim 9. The paint roller covering or dye-feeding roller covering according to claim 12 comprises a pile fiber nonwoven fabric, in which a part of the pile fibers has a vertical orientation and a loop shape.

It is known to use paint rollers or dye-feeding rollers for distributing liquid substances such as paints, lacquers or other substances on large surfaces for painting, for example, walls, facades or ceilings, but also for applying floor coatings. Such paint rollers or dye-feeding rollers have a holder including a handle piece on which a rotatable roller including an absorbent covering is fixed which is also exchangeable.

As such a covering material for paint rollers or dye-feeding rollers, a foam or velour is employed in a known manner, i.e. a fabric including a pile layer.

Such a velour can be manufactured on the basis of two fabric webs which are interconnected by additional warp threads. The warp threads subsequently are cut through so that the warp threads form a pile layer in which the threads are arranged mainly to be vertical.

For use in case of different paints and lacquers and on different surfaces, the material as well as the pile height can be varied and adapted appropriately.

In case of smoother application substrates, short pile heights are recommended. For heavily structured or rough surfaces, coverings having pile heights or web heights of up to 25 mm are employed so as to ensure the application down to places situated low.

The manufacture of such covering fabrics, however, is complicated and cost-intense.

Basically, nonwoven fabrics can be provided comparatively cost-efficiently. Nonwoven fabrics hitherto proposed as covering material, however, are not suitable as a qualitatively equivalent substitute material for velour.

From WO 2002/058006 A2, a hydro-entangled nonwoven fabric is already known. Such nonwoven fabrics, however, are minimally bulky and only have slight absorbency.

DE 41 06 295 A1 discloses a needle-punched nonwoven which, however, is likewise not sufficiently bulky and can only be used in conjunction with an additional foam as applicator means.

U.S. Pat. No. 8,695,151 B2 shows a needle-punched nonwoven, in which a pile structure can be generated by special needles. A disadvantage there is the poor dimensional stability, whereby an additional strengthening layer is needed. The achievable pile height of at maximum 7 mm is too low and significantly restricts the field of application of such a material. Moreover, the bonding of the fibers is rather poor in needle-punched nonwoven fabrics so that fiber tear-out and fluff formation during the use of a dye-feeding roller of such a configuration have to be expected.

From DE 198 39 418 C1, a method for producing bulky, multi-layered pile nonwoven knitted fabrics from single, identical and different nonwoven fabric layers is already known, in which, by means of mesh forming elements, mesh formation layers and pile loops or folded pile layers are formed from fibers or threads.

In a base layer, one or more layers are consecutively drawn in this respect from an additionally supplied nonwoven fabric into pile loops or folded pile heads of the pile layers of the respectively supplied base layer by means of compound needles. The fibers of the additionally supplied fiber nonwoven fabric are formed into a knitted layer and a folded pile layer. The newly formed layer respectively penetrates only the pile layer of the supplied uppermost layer in the area of the pile loops or folded pile heads. Finally, both sides are bonded together.

One-layered or multi-layered pile nonwoven fabrics, folded pile nonwoven fabrics, pile thread fabrics or pile thread woven fabrics can be supplied as the base layer. Indications as to the use of such pile nonwoven fabrics in the context of the problems of high absorbency are not given.

A pile fabric consisting of a textile support structure having a trimming of pile threads anchored in the support structure according to EP 1 163 386 B1 is furthermore known.

The pile threads mainly consist of a multifilament yarn which contains fine filaments, on the one hand, and coarse filaments, on the other, the titer of which is more than 25 times larger than the titer of the fine filaments. Such a pile fabric is suitable for a use as a massage bench covering or as a massage glove.

From the aforementioned, it is a task of the invention to propose a further developed absorbent material on the basis of a nonwoven fabric, a method for producing such a material, as well as specific uses, wherein both a large pile height of the material to be created is to be realized and a minimum fiber tear-out should be guaranteed.

The solution of the invention is performed by a feature combination of the pending claim 1 which is aimed at a novel absorbent material on the basis of a nonwoven fabric.

A further aspect according to the invention is a method for producing an absorbent material on a nonwoven fabric basis according to the teaching of claim 9, and the paint roller or dye-feeding roller according to the subject matter of claim 12.

The absorbent material on a nonwoven fabric basis according to the invention consists of a fibrous gauze preferably having a longitudinally oriented initial fiber position. The fibrous gauze is solidified by mesh formation while obtaining a three-dimensional fiber order.

According to the invention, a fiber pile layer having mainly a vertical fiber orientation is formed, wherein the fiber pile layer has largely preponderantly a loop shape in a manner avoiding fiber tear-out.

In a further development of the invention, a mesh layer and a fiber pile layer are provided.

In one embodiment, a mesh layer can be provided on both sides of the fiber pile layer, wherein the pile layer surface is additionally intermeshed in this respect.

The respective mesh layers may have a different density or porosity.

In one embodiment of the invention, a rear coating of a thermoplastic or thermally cross-linkable material is provided.

According to the invention, the pile height is in the range from 7 to 25 mm, preferably in the range between 4 and 22 mm.

In one configuration of the invention, 5 to 20% by mass of binding fibers may be supplied to the initial fiber mixture.

The use of the presented absorbent material on the nonwoven fabric basis as a covering for devices for applying liquids onto arbitrary surface structures is moreover according to the invention.

Here again, the employment or the use of the covering as a paint roller covering or dye-feeding roller covering or such a coating is according to the invention.

In the method according to the invention for producing the absorbent material on the nonwoven fabric basis, an initial fiber mixture is laid as to form a fibrous gauze.

Subsequently, a densification is performed by means of mesh formation and unilateral fiber pile formation, wherein the obtained fiber pile layer preponderantly is realized in the form of loops.

During the solidification, a base web can be supplied in order to increase the total solidity and dimensional stability of the final product.

Furthermore, there is the possibility of performing an additional, secondary mesh formation of the fiber pile layer surface, wherein this additional mesh formation results in a more open structure as compared to the primary mesh formation.

In a manner according to the invention, a pile fiber nonwoven fabric, in which a part of the pile fibers has a vertical orientation and a loop shape, in summary is employed as a paint roller or dye-feeding covering roller covering or such a coating.

The pile fiber nonwoven fabric employed according to the invention, i.e. a nonwoven fabric solidified by mesh formation, in which a part of the fibers has a mainly vertical orientation and thus forms a pile layer, is a novel means in terms of the use presented herein.

In producing such nonwoven fabrics, a fibrous gauze having preferably a longitudinally oriented fiber position, is first produced from fibers of finite length, i.e. so-called staple fibers.

Optionally, such a fibrous gauze can subsequently be laid in several layers atop one another by means of a transverse applicator, wherein the fibers here are mainly oriented transversely to the machine direction.

A plurality of layers of the same or different fiber orientation can also be laid atop one another.

The thus produced initial fiber web is supplied to a solidification unit.

In such a solidification unit, which is known per se, the fibrous gauze is laid to vertical folds and three-dimensionally deflected by a compound needle, whereby the fibrous gauze is densified and the weight per unit area increased.

The web is pressed into a hook of the respective compound needle by means of a brush-like stuffing element, with the consequence that a mesh can be formed from the staple fibers when the needle is pulled back.

After this solidification, the nonwoven fabric has a fiber pile layer and a mesh layer.

If the thus obtained pile fiber nonwoven fabric is subsequently refined mechanically, for example, roughened or sheared, the top surface of the pile layer can be homogenized.

The mesh structure generated in pile fiber nonwoven fabrics from the employed staple fibers provides for a good bonding of the fibers, which reduces fiber tear-out during use. Furthermore, the pile layer is mainly formed in the form of loops.

In contrast to a pile layer of purely or preponderantly single threads, such as the one developing during the known velour process, the fiber tear-out is further reduced according to the invention, and the elasticity of compression and the values of compression and consequently also the entire stability of the pile layer are increased.

During the solidification, an additional base web can be supplied optionally so as to increase the solidity and the dimensional stability.

In this case, the staple fibers are pulled through the base web by means of the already mentioned compound needle, so that on the one side of the base web, a mesh layer is formed, and a pile layer is formed on the other side. The base web may be present, for example, as a nonwoven fabric, a woven fabric, a mesh fabric or a knitted fabric, but must be able to be penetrated by means of the compound needles without causing the structure to be damaged. Such nonwoven fabrics are known to the skilled person, for example, under the designation Voltex.

Varying the fiber fineness, fiber material and fiber cross-section allows the pile nonwoven structure to be varied from being coarse up to fine. Also, the mesh fineness, i.e. the number of needles per unit of working width, and the mesh length influence decisively the pile density and thus the volume, optics, solidity and elongation of the nonwoven fabric as well a the bonding of the fibers. Varying the production parameters allows the nonwoven fabric according to the invention to be adapted in a simple manner to diverse requirements of the fields of application that are relevant here.

In a further development of the invention, an additional mesh formation of the pile layer surface may be performed so as to further minimize fiber tear-out.

For this purpose, the described pile fiber nonwoven fabric is supplied to a further working station having compound needles such that the compound needles penetrate into the pile layer, capture the pile fibers, and form them into a second mesh layer.

As a result, a three-dimensional nonwoven fabric is formed having intermeshed top surfaces on both sides and an interior pile layer.

Advantageously, the mesh formation on both sides may be performed using different machine parameters, such as mesh fineness or penetration depth, for example, so that a first, denser and firmer mesh side, and a second, more open mesh side will develop.

The material according to the invention has a sufficiently high pile height and absorbency, so that in contrast to already known nonwoven fabrics, an additional layer of textile or foam material for padding and/or improving the absorbency can be dispensed with.

For producing the pile fiber nonwoven fabric, fibers of natural origin, such as wool, cotton or viscose, for example, but also synthetic fibers such as polyester or polyamide, as well as various mixtures of different phases may be employed.

The fineness of the fibers should here be in the range from 2.5 to 22 dtex, preferably in the range from 3.3 to 15 dtex.

The staple length of the fibers is in the range from 27 to 120 mm, wherein a staple length of 60 mm has proven to be particularly advantageous to achieve a good fiber bonding and high pile heights.

The fiber mixture preferably contains a portion of 5 to 30% by mass of binding fibers. These binding fibers have a melting point which is at least 20° C. below the melting or decomposition temperature of the remaining fiber materials. The binding fibers may also be realized as bicomponent fibers, wherein the components have different melting temperatures, and the component having the lower melting temperature acts as a binding agent.

Suitable binding fibers are based, for example, on polylactide, polypropylene or a core-jacket bicomponent fiber having a core of polyethylene terephthalate and a jacket of low-melting co-polyester.

If such binding fibers are employed, after the solidification by means of mesh-bonding, a temperature treatment is performed, during which the nonwoven fabric is heated to a temperature above the melting point of the binding fiber so that the binding fibers melt at least in part and produce an adhesive connection between the remaining fibers. Hereby, the fiber bonding is increased and the fiber tear-out further minimized, and the dimensional stability of the product is improved.

In order to further improve the dimensional stability of the covering material and its adhesion to a core material, a rear coating of a thermoplastic or thermally cross-linkable material may be applied to the side facing away from the pile layer.

This coating may be performed, for example, in form of an aqueous polymer dispersion on the basis of polyacrylate or ethylene-vinyl acetate co-polymer as a meltable powder or as a hotmelt application.

Preferably, a film or an adhesive web of a thermoplastic polymer, such as, for example, polyester, polyethylene, polypropylene or polyurethane is laminated, which is performed advantageously at the same time as or also directly following the already described temperature treatment step.

The nonwoven fabrics according to the invention typically have a surface weight from 200 to 700 g/m², preferably 300 to 550 g/m², and a pile height from 4 to 25 mm, preferably 7 to 22 mm.

The invention will be explained below by means of examples.

A first example takes a fiber mixture of polyester 80% 7 dtex, staple length 60 mm; 20% dtex, staple length 76 mm as a basis and is processed into a fibrous gauze having longitudinally oriented fibers.

This fibrous gauze is supplied to a solidification unit Malimo, type Kunit, in a machine gauge F18 with a densification of 1:8, wherein one side is intermeshed while forming piles.

At a surface weight of 400 g/m², the thus produced nonwoven Kunit fabric has a pile height of 9 mm.

A second example takes a fiber mixture of polyester 72% 7 dtex, staple length 60 mm; 18% 12 dtex, staple length 76 mm, 10% core-jacket bicomponent fiber, 4.4 dtex, staple length 56 mm as a basis.

This mixture is processed into a fibrous gauze having longitudinally oriented fibers. This fibrous gauze is supplied to a solidification unit Malimo, type Kunit, in a machine gauge F18 with a densification of 1:8, wherein a first side is intermeshed while forming piles. Subsequently, in a solidification unit Malimo, type Multiknit, in machine gauge F18, the pile side is intermeshed with a low penetration depth. As a result, a nonwoven Multiknit fabric is generated, which is subsequently subjected to a temperature treatment at 160° C. in a flatbed laminating machine. At the same time, a co-polyester film with a surface weight of 70 g/m² and having a melting point of 130° C. is supplied to the laminating machine and laminated upon the first mesh side. At a surface weight of the nonwoven Multiknit fabric of 450 g/m², the material thus obtained has a pile height of 7 mm.

By way of comparison, a velour fabric known from the state of the art and of 100% polyester having a rear coating of ethylene-vinyl acetate co-polymer, at a surface weight of 620 g/m² in total, has a pile height of 10 mm. A known needle-punched nonwoven fabric of 100% polyester has a pile height of 3 to 7 mm at a surface weight of 400 g/m².

The materials according to the invention consequently allow a comparable pile height to be realized at a lower surface weight than in known materials.

1. An absorbent material on a nonwoven fabric basis, consisting of a fibrous gauze preferably having a longitudinally oriented initial fiber position, which is solidified by mesh formation while obtaining a three-dimensional fiber order,
characterized in that
the fiber pile layer having a mainly vertical fiber orientation is formed, wherein the fiber pile layer has largely preponderantly a loop shape in a manner avoiding fiber tear-out.

2. The absorbent material on a nonwoven fabric basis according to claim 1,
characterized in that
a mesh layer and a fiber pile layer are provided.

3. The absorbent material on a nonwoven fabric basis according to claim 1,
characterized in that
a mesh layer is provided on both sides of the fiber pile layer, wherein the pile layer surface is additionally intermeshed in this respect, and the respective mesh layers have different density or porosity.

4. The absorbent material on a nonwoven fabric basis according to any one of the preceding claims,
characterized in that
a rear coating of a thermoplastic or thermally cross-linkable material is provided.

5. The absorbent material on a nonwoven fabric basis according to any one of the preceding claims,
characterized in that
the pile height is in the range from 7 to 25 mm, preferably in the range from 4 to 22 mm.

6. The absorbent material on a nonwoven fabric basis according to any one of the preceding claims,
characterized in that
the fiber mixture contains binding fibers from substantially 5 to 20% by mass.

7. The absorbent material on a nonwoven fabric basis according to any one of the preceding claims,
characterized by
its use as a covering for devices for applying liquids onto arbitrary surface structures.

8. The absorbent material on a nonwoven fabric basis according to claim 7,
characterized in that
the covering is formed as a paint roller covering or a dye-feeding roller covering.

9. A method for producing an absorbent material on a nonwoven fabric basis according to any one of the preceding claims,
characterized in that
an initial fiber mixture is laid as to form a fibrous gauze, subsequently, a densification is performed by means of mesh formation and unilateral fiber pile formation, wherein the obtained fiber pile layer preponderantly is realized in the form of loops.

10. The method according to claim 9,
characterized in that
during the solidification, a base web is supplied in order to increase the final solidity and dimensional stability.

11. The method according to claim 9 or 10,
characterized in that
an additional mesh formation of the fiber pile layer surface is performed, wherein this additional mesh formation results in a more open structure as compared to the primary mesh formation.

12. A paint roller covering or dye-feeding roller covering, comprising a pile fiber nonwoven fabric, in which a part of the pile fibers has a vertical orientation and a loop shape.
